(19) United States
(12) Patent Application Publication
(10) Pub. No.: US 2009/0157426 A1
(43) Pub. Date: Jun. 18, 2009

(54) METHODS, APPARATUSES & COMPUTER PROGRAM PRODUCTS FOR FACILITATING EFFICIENT DISTRIBUTION OF DATA WITHIN A SYSTEM

(75) Inventors: Arien Malec, Oakland, CA (US); Ed Cortes, San Francisco, CA (US); Angela Godin, Oakland, CA (US); Greg White, San Anselmo, CA (US); Steven M. Wasson, Alameda, CA (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: McKesson Financial Holdings Limited, Hamilton (BM)

(21) Appl. No.: 11/955,203

(22) Filed: Dec. 12, 2007

(51) Int. Cl. G06Q 50/00; G06F 17/00

(52) U.S. Cl. 705/3

(57) ABSTRACT

A method, apparatus, system and computer program product are provided for facilitating connection of source devices that are capable of generating data to one or more destination devices which may receive the generated data. The data generated by the source devices may be in different data formats and the source devices may be maintained and operated by different institutions and facilities. Similarly, the destination devices may be maintained and operated by different institutions and facilities. In this regard, an apparatus may be configured to receive the data generated by the source devices and convert the data to one or more codes which represent the results of the data generated by the source devices. The codes may be used by the apparatus to convert or translate the data into a format or template that is specific to an institution or facility that maintains or operates one of the destination devices.

### FIELD OF THE INVENTION

In general, exemplary embodiments of the present invention relate to a system for securely connecting one or more electronic devices that are capable of generating and reporting data such as, for example, medical data to one or more other electronic devices which are able to receive results associated with the medical data.

### BACKGROUND OF THE INVENTION

Integral to the modern medical industry is the reporting of medical data to physicians, health care providers, patients, etc. in a format that is useful and convenient. Currently, one such approach to delivering medical data such as medical records consists of paper-based reporting. For instance, a physician conducting a physical for a patient may mail the results to the patient in paper-based charts. Likewise, laboratories which conducted medical tests on a patient may mail the results of the tests to the requesting physician, hospital, clinic or the like. Another mechanism of distributing medical data consists of utilizing electronic devices. For instance, a laboratory conducting a medical test on behalf of a hospital or physician may send these results to the hospital or physician by utilizing an electronic device such as a personal computer. In this regard, presently, medical data may be sent from one electronic device which may generate the medical data to another electronic device which may request the medical data, i.e., in a point-to-point electronic transmission.

However, there are drawbacks to using point-to-point electronic transmission of medical data such as laboratory data or the like. For instance, point-to-point electronic transmission of laboratory data is expensive for laboratory systems to operate due to the need to support multiple formats of medical data that may be utilized by entities such as clinics, hospitals, physicians and the like which request the medical data from the laboratory system. Additionally, point-to-point electronic transmission of medical data is expensive and inefficient to operate because a medical system such as a laboratory system typically needs to support multiple secured network connections to various entities such as a clinic, hospital, physicians practice or the like. Moreover, oftentimes the operating costs of the clinics, hospitals or the like that request the medical data from a laboratory or the like are increased because these entities also typically need to support multiple network connections to various medical facilities such as laboratories, other physicians, clinics, hospitals or the like as well as patients and additionally typically need to support multiple formats of medical data provided by different entities.

Additionally, there are drawbacks of using paper-based reporting of medical data. For instance, paper based-reporting is oftentimes a slow and costly mechanism of reporting medical data to a requesting entity such as a physician, clinic or the like. For instance, medical data sent via mail such as postal mail may take longer to receive than desired and the costs associated with postage combined with having dedicated staff members to facilitate handling of the medical data and sending of the medical data to the requestor can be expensive.

Despite the above drawbacks, today's hospital laboratories, reference laboratories, radiology systems, transcription offices and other similar medical systems may have a need to deliver medical results to physicians who may themselves utilize a number of electronic medical record systems, or who may utilize a traditional paper charting process to manage medical data.

Given the above described problems, there may be a need to develop a system that is capable of connecting one or more electronic devices which generate medical data with one or more other electronic devices which are to receive the generated medical data in a secure manner.

### BRIEF SUMMARY OF THE INVENTION

Methods, apparatuses, and computer program products are therefore provided which provide a system for operating securely over a network that connects multiple electronic devices generating data such as medical data, (e.g., laboratory results) which may be in different data formats, to one or more electronic devices requesting the medical data on behalf of an entity or institution such as a clinic, health care provider, physician's facility, etc. The exemplary embodiments of the present invention facilitate simple and efficient handling of orders, queries and other needs for medical data within the system.

For example, the system automates transformation of laboratory test identifiers in messages relating to medical data to standard laboratory test identifiers such as Logical Observation Identifiers Names and Codes (LOINCs) which may be utilized to translate data in a message to a template that also may be specifically used by a particular health care entity (e.g., an Electronic Medical Records System). In other words, the system provides automation of translation of medical data generated at one or more source devices to one or more data formats which conform to the needs and requirements of one or more destination devices.

Additionally, the system enables connectivity to multiple electronic medical records or other systems for receipt of medical data. For instance, the system of the exemplary embodiments of the present invention supports multiple sources for generating medical data of different types (e.g., laboratory, radiology, transcription, etc.). Additionally, the exemplary embodiments of the present invention also facilitate standardization of transmission of medical data as well as error handling procedures. Since multiple source devices capable of generating medical data may connect to one or more destination devices and given that the system is capable of handling translation of the medical data based on the requirements of the particular destination device, the operational costs of the system of the exemplary embodiments of the present invention may be reduced.

In accordance with one aspect of the present invention a method and computer program product are provided. The method and computer program product may include receiving medical data which includes one or more medical codes representative of results and translating the medical codes to corresponding different codes which are also representative of the results. The method and computer program product further includes generating one or more templates based on the different codes. The templates include data indicative of the results. The method and computer program product further comprise sending the one or more templates to a respective one of one or more entities.

According to another aspect of the present invention an apparatus is provided for facilitating efficient distribution of medical data generated by source devices to be sent to destination devices. The apparatus may include a processing element that is configured to receive medical data which includes one or more medical codes representative of results and translate the one or more medical codes to corresponding different codes which are also representative of the results. The processing element is also configured to generate one or more templates based on the different codes. The templates include data indicative of the results. The processing element of the apparatus is also configured to send the one or more templates to a respective one of one or more entities.

In accordance with yet another aspect of the invention a system is provided. The system may include an apparatus including a processing element. The processing element of the apparatus is configured to receive medical data which includes one or more medical codes representative of results and translate the one or more medical codes to corresponding different codes which are also representative of the results. The processing element of the apparatus is also configured to generate one or more templates based on the different codes. The templates comprise data indicative of the results. The system also includes an entity which includes a processing element configured to receive the one or more templates and display the one or more templates. The one or more templates may consist of medical data such as clinical or laboratory results that may be seen on the display by a user such as medical personnel, patients, etc.

### BRIEF DESCRIPTION OF THE SEVERAL VIEWS OF THE DRAWINGS

Having thus described the invention in general terms, reference will now be made to the accompanying drawings, which are not necessarily drawn to scale, and wherein:

FIG. 1 is a schematic block diagram of an entity according to an exemplary embodiment of the invention;

FIG. 2 is a schematic block diagram of a system according to an exemplary embodiment of the present invention;

FIG. 3 is a schematic block diagram of a computing device according to an exemplary embodiment of the present invention;

FIG. 4 illustrates a flowchart of a system for facilitating distribution of medical data;

FIG. 5 illustrates a message containing medical data according to an exemplary embodiment of the present invention;

FIG. 6 illustrates a translated message according to an exemplary embodiment of the present invention;

FIG. 7A illustrates a results viewer displaying data in a template corresponding to data in a message according to an exemplary embodiment of the invention;

FIG. 7B illustrates templates in a results viewer corresponding to one or more codes in a message according to an exemplary embodiment of the present invention;

FIG. 7C illustrates codes corresponding to laboratory results and selection of a template corresponding to one or more of the laboratory results according to an exemplary embodiment of the present invention;

FIG. 7D illustrates a template consisting of fields for selecting data according to an exemplary embodiment of the present invention;

FIG. 7E illustrates one or more templates relating to laboratory results which may be sent to a patient according to an exemplary embodiment of the present invention; and

FIG. 7F illustrates a template that may be sent to a patient in which data in the template is populated and generated from another template according to an exemplary embodiment of the present invention.

### DETAILED DESCRIPTION OF THE INVENTION

The present invention now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

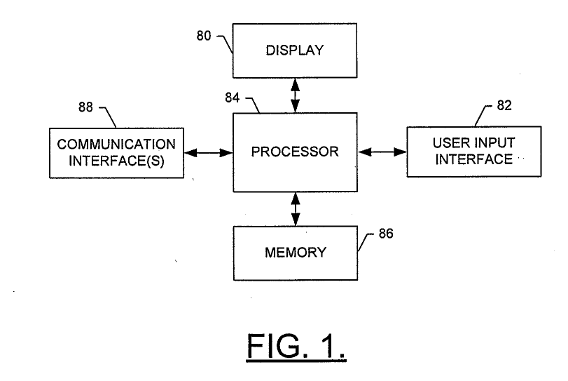

FIG. 1 illustrates a block diagram of an entity that would benefit from the present invention. The entity is capable of operating as an electronic device such as a client, server, computing device or the like, in accordance with one embodiment of the present invention. The entity includes various means for performing one or more functions in accordance with exemplary embodiments of the present invention, including those more particularly shown and described herein. It should be understood, however, that one or more of the entities may include alternative means for performing one or more like functions, without departing from the spirit and scope of the present invention. More particularly, for example, as shown in FIG. 1, the entity can include a processor 84 connected to a memory 86. The memory can comprise volatile and/or non-volatile memory, and typically stores content, data or the like. For example, the memory may store content transmitted from, and/or received by, the entity. The memory is capable of storing data including but not limited to medical data such as laboratory results, diagnoses, patient prescriptions, or the like. Also for example, the memory typically stores client applications, instructions or the like for the processor 84 to perform steps associated with operation of the entity in accordance with embodiments of the present invention. As explained below, for example, the memory can store one or more client application(s) such as for example software associated with the generation of medical data.

The entity can include one or more logic elements for performing various functions of one or more client application(s). The logic elements performing the functions of one or more client applications can be embodied in an integrated circuit assembly including one or more integrated circuits integral or otherwise in communication with a respective network entity (i.e., computing system, client, server, etc.) or more particularly, for example, a processor 84 of the respective network entity.

In addition to the memory 86, the processor 84 can also be connected to at least one interface or other means for displaying, transmitting and/or receiving data, content or the like. The interface(s) can include at least one communication interface 88 or other means for transmitting and/or receiving data, content or the like. In this regard, the communication interface 88 may include, for example, an antenna and supporting hardware and/or software for enabling communications with a wireless communication network. For example, the communication interface(s) can include a first communication interface for connecting to a first network, and a second communication interface for connecting to a second network. In this regard, the entity is capable of communicating with other electronic devices over a network such as a Local Area Network (LAN), Wide Area Network (WLAN), Wireless Wide Area Network (WWAN), the Internet, or the like. Alternatively, the communication interface can support a wired connection with the respective network. In addition to the communication interface(s), the interface(s) can also include at least one user interface that can include one or more earphones and/or speakers, a display 80, and/or a user input interface 82. The display 80 is capable of displaying information including but not limited to medical data. In this regard, the display may be a results viewer capable of showing results of medical tests, diagnoses or the like. The user input interface, in turn, can comprise any of a number of devices allowing the entity to receive data from a user, such as a microphone, a keypad, a touch display, a joystick, image capture device or other input device.

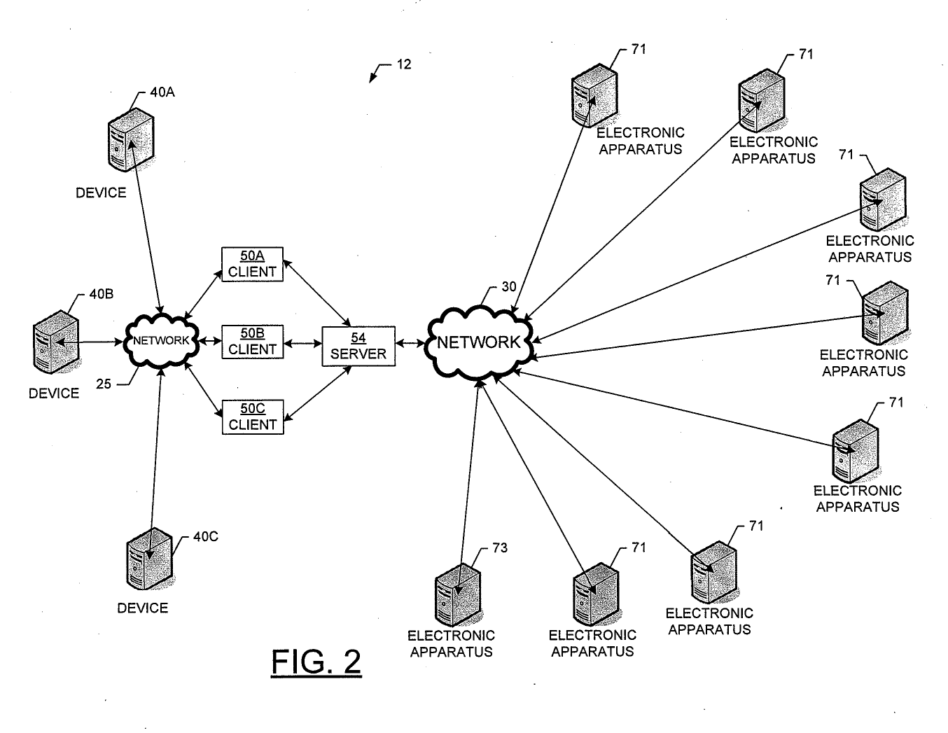

Reference is now made to FIG. 2, which is a block diagram of an overall system that would benefit from exemplary embodiments of the present invention. It should be pointed out that each of the components of FIG. 2 may comprise the elements of the entity illustrated in FIG. 1. As shown in FIG. 2, the system 12 may include a server 54 (also referred to herein as a Pathways Interface Manager) capable of receiving data from and transmitting data to the clients 50A, 50B and 50C (also referred to herein as Secure Object Clients (SoCs)). In an exemplary embodiment, the clients 50A, 50A and 50C may be personal computers (PCs), laptops, personal digital assistants (PDAs) or other electronic devices that may be fixed or mobile. The clients 50A, 50B and 50C are capable of communicating with one or more electronic devices 40A, 40B, and 40C over a communication network 25 such as Local Area Network (LAN), Wide Area Network (WAN) (e.g., the Internet), Wireless Local Area Network (WLAN), Wireless Wide Area Network (WWAN), metropolitan area network (MAN) or the like. The electronic devices 40A, 40B and 40C may include but are not limited to personal computers (PCs), laptops, PDAs or the like and the electronic devices 40A, 40B and 40C may be operated by a Hospital, Laboratory Information System (LIS), Radiology Information System (RIS), Transcription System or similar institution capable of handling medical data. In an exemplary alternative embodiment, one or more of the electronic devices 40A, 40B and 40C may function as an interface such as an interface engine (IE) and receive medical data (e.g., test results) from an institution or similar network entity which the IE is capable of sending to one or more of the clients. The electronic devices 40A, 40B and 40C may communicate with the SoC clients 40A, 40B and 40C by using a Health Level 7 (HL7) messaging protocol which supports the exchange, sharing, integration and retrieval of electronic medical or health information. It should be pointed out that while three electronic devices 40A, 40B and 40C as well as three clients 50A, 50B and 50C are shown in FIG. 2, there may be any number of electronic devices and clients in the system of FIG. 2 having capabilities analogous to those of electronic devices 40A, 40B and 40C and clients 50A, 50B and 50C, respectively. Additionally, the clients 50A, 50B and 50C may send data to and receive data from the server 54 by utilizing at least one of communication interfaces 88. Communication of data between the clients 50 and server 54 may occur for example by utilizing a Simple Object Access Protocol (SOAP) also referred to as Service Oriented Architecture Protocol which use HyperText Transfer Protocol (HTTP) messages.

Each of the electronic apparatuses 71 and 73 may include but are not limited to personal computers, laptops, servers, PDAs or any other suitable electronic device that is fixed or mobile. Each of the electronic apparatuses 71 and 73 may be operated by an Electronic Medical Record System (EMR) including but not limited to the record systems of clinics, health care facilities, or hospitals, etc. For instance, the EMR may consist of EMR vendors such as NextGen, GE Centricity, Horizon Ambulatory Care, Cerner PowerChart, Epic Care, etc. which are utilized by clinics. While seven electronic apparatuses 71 and one electronic apparatus 73 are shown in FIG. 2 for illustration purposes it should be noted that the system 12 may include any suitable number of electronic apparatuses. The electronic apparatuses 71 and 73 may communicate with the server 54 over network 30, such as a wired or wireless local area network (LAN), a WLAN, WAN, (e.g., Internet) WWAN or a metropolitan area network (MAN). In this regard, each of the electronic apparatuses 71 and 73 may send a message to server 54, via network 30 for a request of medical data (e.g., laboratory test conducted for one of its patients) from one or more of electronic devices 50A, 50B or 50C. This request may be forwarded by the server 54 to one of the clients 50A, 50B and 50C and then sent to one or more respective electronic devices 50A, 50B or 50C. In an exemplary embodiment, the request for medical data by the electronic apparatuses may include but is not limited to an e-mail message, facsimile, etc. originated by the personnel (e.g., a physician(s), nurse, etc.) of the EMRs.

Additionally, it should be pointed out that each electronic device 40A, 40B and 40C may store subscription information in a memory such as memory 86 indicating that a respective EMR maintaining and operating one or more of electronic apparatuses 71 and 73 subscribes to the services of the system 12 and when medical data is generated on behalf of the subscriber of the EMR, the respective electronic device 40A, 40B, 40C may automatically send corresponding medical data (e.g., test results of one of the EMR's patients) to a client 50A, 50B or 50C to be sent to the respective electronic apparatus via server 54, without waiting on a request from the electronic apparatus 71 or 73.

As mentioned above, each of the electronic devices 40A, 40B and 40C are capable of sending data to one or more clients 50A, 50B and 50C via network 25. This data sent from the electronic devices 40A, 40B and 40C may consist of medical data including but not limited to the results of laboratory tests, medical treatments, medical diagnosis, prescription drugs and the like. In an exemplary alternative embodiment, electronic device 40A is capable of sending data to SoC 50A, electronic device 40B is capable of sending data to SoC 50B and electronic device 40C is capable of sending data to SoC 50C. In this regard, for each electronic device there may be a corresponding SoC in the system 12. Additionally, each of the electronic devices 40A, 40B and 40C may send the medical data to the clients 50A, 50B and 50C and this data may be in different data formats depending on the data format utilized by the corresponding EMR.

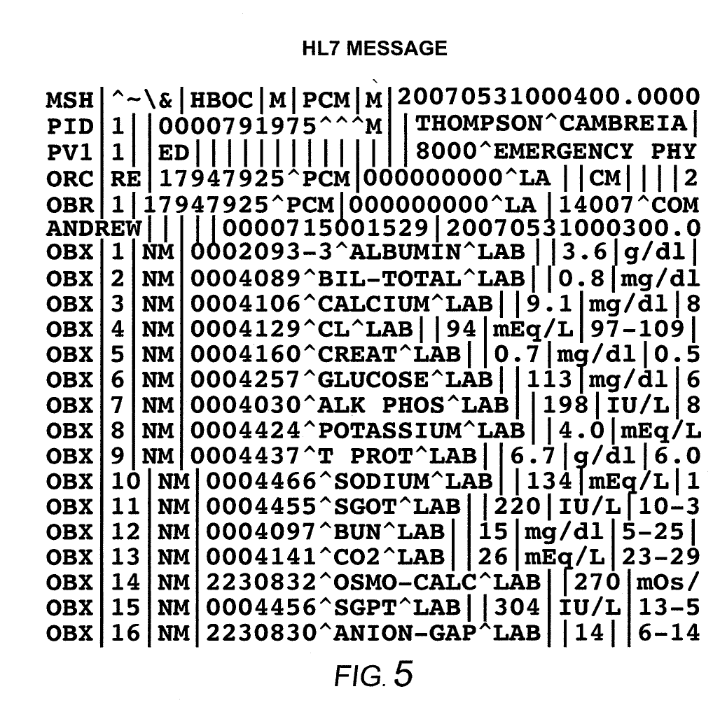

The medical data sent from the electronic devices 40A, 40B and 40C to the clients 50A, 50B and 50 which are intended for distribution to one or more of the electronic apparatuses may be in the form of one or more messages. These messages may be in a HL7 format according to the HL7 standard or any other suitable format or standard and these messages may include test or result codes (e.g., codes relating to results from a cholesterol panel), as shown in FIG. 5. Additionally, the messages sent from the electronic devices to the clients which may utilize HL7 may also be Order Request (ORU) messages or Medical Document (MDM) messages which may contain result or test order data and/or data associated with medical documents. In this regard, if the processor 84 of the client determines that the message received from the electronic device is not an ORU message or an MDM message, the processor 84 may delete or erase this message(s). The processor 84 of the client will create a log in which the messages which are not ORU or MDM messages will be written. In an alternative exemplary embodiment, the ORU or MDM message may include an optional field associated with a patient class (e.g., child). For instance, the optional field may have a box associated with the patient class which may be selected or checked and only if this patient class is selected or checked will medical data associated with the respective patient be sent to the server 54 for delivery to an electronic apparatus of an Electronic Medical Records System (EMR).

The processor 84 of the clients 50A, 50B and 50C includes circuitry to validate the person/institution (e.g., EMR) desiring to receive the medical data and route the medical data to the appropriate electronic apparatus via the server 54, as well as translate the received medical data to an appropriate format. For instance, a respective electronic device 40A, 40B, 40C may send the subscription file to a client along with the medical data in the message. In this regard, the processor 84 of the client is able to examine the subscription file and determine if information included in the subscription file identifies the EMR in which the medical data is to be sent. In an exemplary alternative embodiment, processor 84 of the client may validate the person (e.g., primary person) requesting the medical data that it received from an electronic device by examining the information included in the subscription file and determining whether this information specifies an identification (ID) of personnel (e.g., an ordering physician's ID, for example the physician's name or a numeric code associated with the ordering physician) of the EMR which has the respective electronic apparatus 71 or 73 in which the medical data is to be delivered. If the processor 84 of the client determines that the identification of the personnel is not contained in the subscription file, the message containing the medical data is not sent by the client to the electronic apparatus of the EMR associated with the personnel desiring to receive the medical data and instead this medical data is deleted or erased by the processor 84 of the client. On the other hand, if the processor 84 of the client determines that the ID of the personnel is in the subscription file, the processor 84 determines which electronic apparatus(es) of the EMRs, to route the message containing the medical data. For instance, the processor 84 of the client is capable of determining that the person who was validated by examining the subscription file is affiliated with the electronic apparatus 71 of a clinic. In this regard, the processor 84 of the client may route the message to the server 54 for delivery to the respective electronic apparatus (e.g., electronic apparatus 71) of the EMR in which the personnel is affiliated with.

Additionally, it should be pointed out that the identification of personnel may consist of an ID associated with another person (i.e., secondary person) such as for example a secondary physician who subscribes to the service of system 12. For instance, the secondary physician may be carbon copied (cc) in the request (e.g., e-mail) sent from an electronic apparatus to an electronic device requesting medical data. If an ID associated with the secondary physician is in the subscription file indicating that the secondary physician is a subscriber to the service of system 12, the processor 84 is capable of validating the secondary physician. In this regard, if the secondary physician is validated, the message containing the medical data may be sent to the electronic apparatus operated on behalf of the EMR with which the secondary physician is affiliated. It should be pointed out that the electronic apparatus associated with the secondary person may be different than the electronic apparatus associated with the primary person. If the secondary person (e.g., secondary physician) is not found in the subscription file by processor 84, the message containing the medical data will not be sent to the electronic apparatus associated with the EMR of the secondary physician and an error will be written to an error log stored in memory 86 of the client. Moreover, the message may be deleted or erased by the processor 84 of the respective client.

In an exemplary alternative embodiment, the message received by the clients 50A, 50B and 50C from one or more of the electronic devices 40A, 40B or 40C may include one or more fields for validation with the subscription file that is provided by an electronic device 40A, 40B, or 40C which may be operated on behalf of a hospital for example. The additional fields include but are not limited to attending doctor, referring physician, consulting doctor, other healthcare provider, primary care provider, principal results interpreter, primary activity provider and the like. If any of these fields does not contain a provider ID that is defined in the subscription file, the processor 84 of the client may not send the associated message to server 54 for delivery to an electronic device and may erase or delete the message.

Furthermore, the processor 84 of the client is capable of translating a provider/personnel ID (e.g., primary/secondary person such as ordering physician and secondary physician, identifier of EMR, etc.) that is utilized by an entity or institution maintaining electronic devices 40A, 40B or 40C to the corresponding ID utilized by the entity or institution (e.g., EMR operating electronic apparatus 71 or 73) in which the medical data in the message is to be sent. It should be pointed out that the processor 84 of the client may translate the provider/personnel ID utilized by the electronic devices 40A, 40B and 40C to that employed by the electronic apparatuses 71 and 73 by comparing an ID(s) in the subscription file with a corresponding ID in a translation table within memory 86 of the client. For instance, when the processor 84 identifies an ID (e.g., a string of numbers) in the translation table that corresponds to an ID in the subscription file, the processor is able to translate the provider/personnel ID utilized by the entity maintaining the electronic device to the ID (e.g., provider/personnel ID) utilized by the respective EMR, maintaining an electronic apparatus(es), in which the message generated by the electronic device is to be sent. If the client is unable to identify a translation for the ID in the translation table, the processor 84 of the client may include data in an error log specifying that a translation was not found for the corresponding ID(s) and the corresponding message associated with ID sent by an electronic device (e.g., electronic device 40A) may be erased or deleted by the client.

The processor 84 of the client is also capable of translating test or result codes contained within the messages sent from the electronic devices 40A, 40B, or 40C to that of Logical Observation Identifiers Names and Codes (LOINC) which is a standard for identifying laboratory observations, clinical results or the like. For instance, health information may be identified by multiple code values that may vary according to the institution producing associated results. In this regard, each of the institutions (e.g., hospitals, Laboratory Information System, Radiology Information System or Transcription System, etc.) operating the electronic devices 40A, 40B and 40C may employ different codes to denote test data such as laboratory tests, clinical observations and the like. By using the LOINC standard, the processor 84 of the client is able to translate the result or test codes in the message sent from an electronic device to universal code names and identifiers such as LOINCs which relate to medical terminology corresponding to an electronic health record. For example, result or test code in a message sent from an electronic device may relate to cholesterol tests, glucose levels, etc. In this regard, the processor of the clients may translate the result or test code in the message sent from an electronic device to LOINCs for cholesterol and glucose levels such as 2093-3 and 0012990, respectively. These LOINCs may be stored in memory 86 of the client, retrieved by the processor 84 of the client and transmitted to the server 54 so that the medical data in the messages can be identified and viewed by the respective electronic apparatus(es) in the manner discussed more fully below.

As an example of a client translating the test or result codes in the message consider the following discrete laboratory results that may be in a message such as an ORU or an MDM message sent from an electronic device such as for example electronic device 40A of a hospital to a client (e.g., client 40A).

Discrete Laboratory Results:

OBR|1|654445-3|5525|88782\hat{ }ELECTROLYTES PANEL
7\hat{ }LN|||200703010800||. . .
OBX|1|NM|55411\hat{ }Sodium\hat{ }LN||150|mmol/L|136-148|H|||F||. . .
OBX|1|NM|56980\hat{ }POTASSIUM\hat{ }LN||4.5|mmol/L|3.5-5.0|N|||F||. . .
OBX|1|NM|23565\hat{ }CHLORIDE\hat{ }LN||102|mmol/L|94-105|N|||F||. . .
OBX|1|NM|3297\hat{ }CARBON DIOXIDE\hat{ }LN||27|mmol/L|24-31|N|||F||. . .

The order test code is displayed in the OBR.4.1 field corresponding to “88782”. This code may be translated by the respective client (in this example client 50A) to a corresponding LOINC that is supported by the client prior to sending the message to the server 54 which may translate the message sent by the client to a template that is specific to an EMR as described below. The reportable result codes are illustrated in the OBX.3.1 field corresponding to “55411, “56980,” “23565,” and “3297”. These codes may also be translated by the respective client (e.g., client 50A) to corresponding LOINCs that are supported by the client(s) prior to sending the message to the server 54. In an alternative exemplary embodiment, the client may send the ORU or MDM message to the server 54 without translating the test and result codes in the message and the server 54 may translate the test and result codes in the message to LOINCs.

As another example of a client translating the test or result codes in a message received by an electronic device (at a hospital for example) consider the following microbiology discrete results relating to organism identification and results associated with tests performed on a child that may be in a message such as an ORU or an MDM message sent from an electronic device such as for example electronic device 40B of a Laboratory Information System to a client (e.g., client 50B). The order test code is displayed in the OBR.4.1 field corresponding to “2454” and “8877”. These codes may be translated by the respective client (in this example client 50B) to corresponding LOINCs that are supported by the client which may be sent to the server 54. The reportable result codes are illustrated in the OBX.3.1 field corresponding to “5441”, “281”, “301”, “242”, “600”, and “553”. These codes may also be translated by the respective client (e.g., client 50B) to corresponding LOINCs that are supported by the client(s) which may be sent to the server 54.

Microbiology - discrete results (organism identification):
OBR|1|46545|4448|2454\hat{ }Urine Culture|||200703010800||. . .
OBX|1|ST|5441\hat{ }MICROORGANISM IDENTIFIED\hat{ }LN||\hat{ }E Coli||||||F||. . .
OBX|1|ST|5441\hat{ }MICROORGANISM IDENTIFIED\hat{ }LN||\hat{ }S
AUREUS||||||F||. . .
Microbiology - discrete results (Child result to the one above with
Susceptibility):
OBR|1|46545|5120|8877\hat{ }Susceptibility MIC|||200703030900||. . .
OBX|1|ST|281\hat{ }AMIPICILLIN\hat{ }LN||<2|ug/ml||S|||F||. . .
OBX|1|ST|301\hat{ }CARBENICILLIN\hat{ }LN||<16 |ug/ml||S|||F||. . .
OBX|1|ST|242\hat{ }GENTAMICIN\hat{ }LN||<2 |ug/ml||S|||F||. . .
OBX|1|ST|600\hat{ }TETRACYCLINE\hat{ }LN||<1 |ug/ml||S|||F||. . .
OBX|1|ST|553\hat{ }CEFUROXIME\hat{ }LN||<2 |ug/ml||S|||F||. . .

It should be pointed out that if a LOINC(s) is not supported by a client 50A, 50B or 50C which relates to data in the message received by an electronic apparatus, the processor 84 of a respective client(s) may create a log stored in memory 86 of the client. The log may be written with data associated with the corresponding message indicating that the LOINC(s) was not supported by the client. In this regard, the ORU or MDM message sent from the electronic device to the client may be forwarded by the client to the corresponding electronic apparatus via server 54. In this manner, the processor 84 of the electronic apparatus may invoke an application stored in its memory such as xlate or a Tool Command Language (TCL) script in order to translate the medical data associated with the test or result codes in the message to their internal system codes so that the medical data can be identified and viewed by the respective EMR.

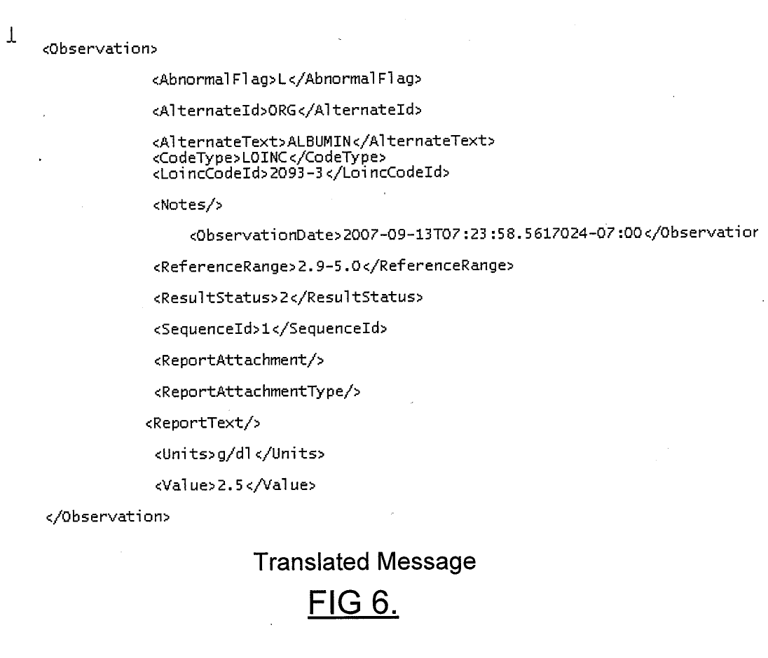

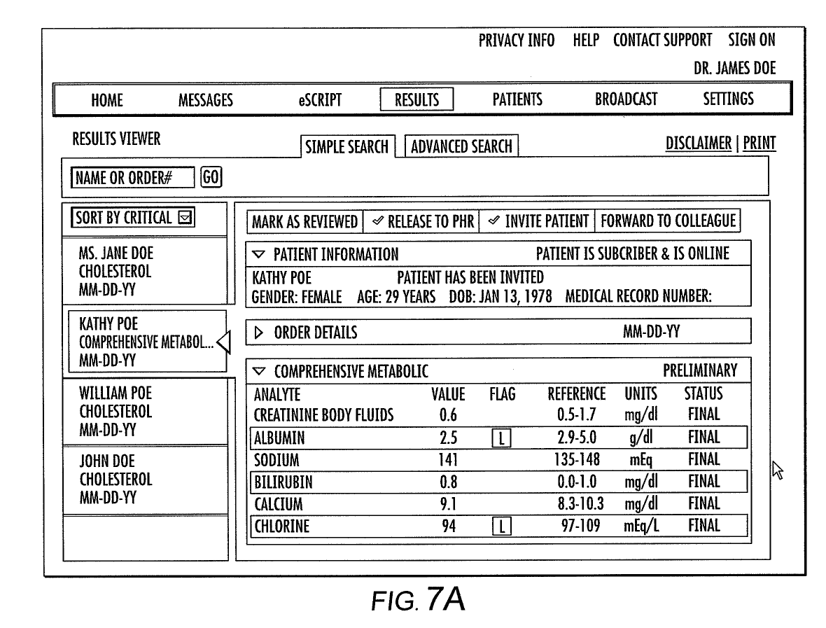

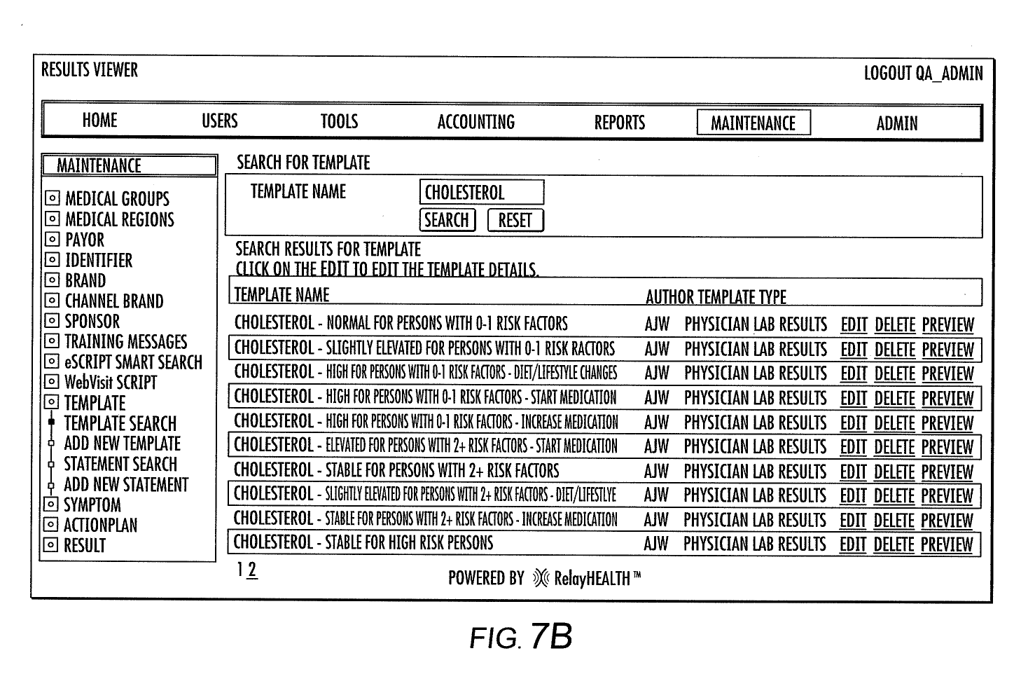

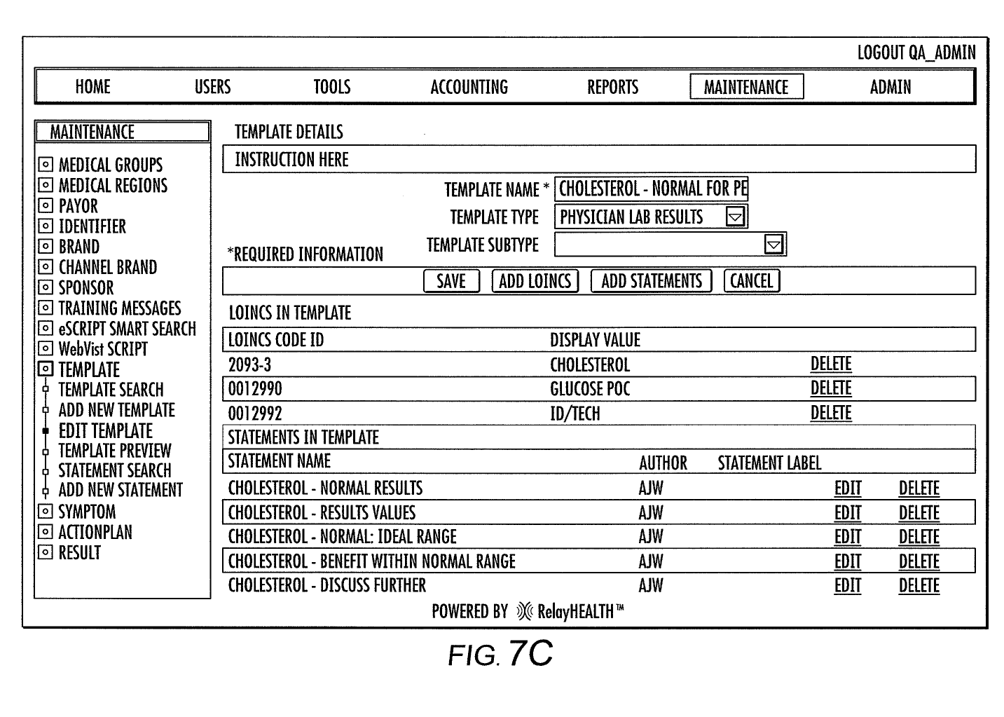

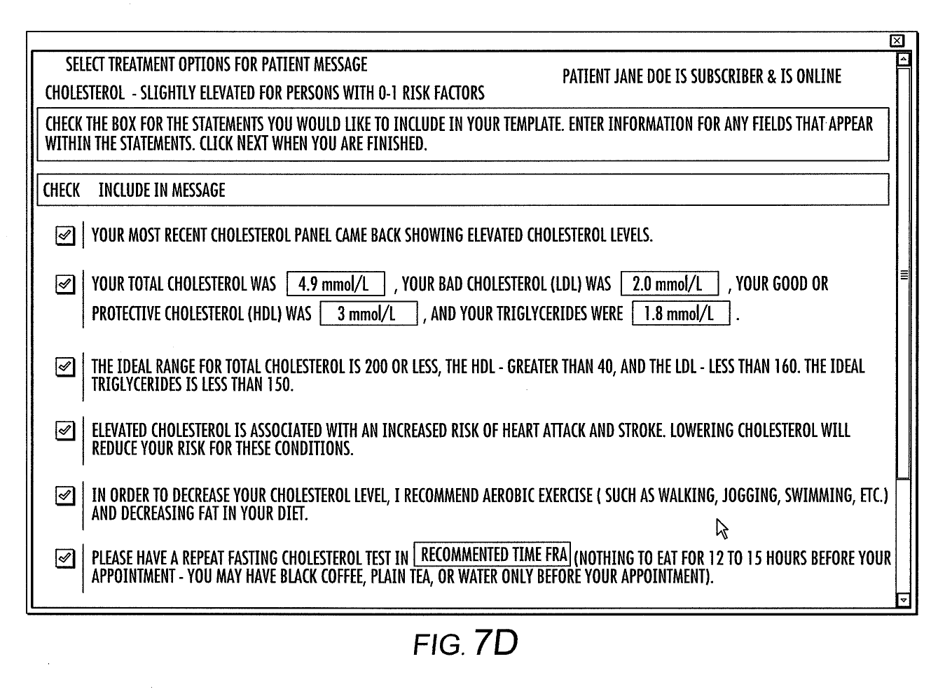

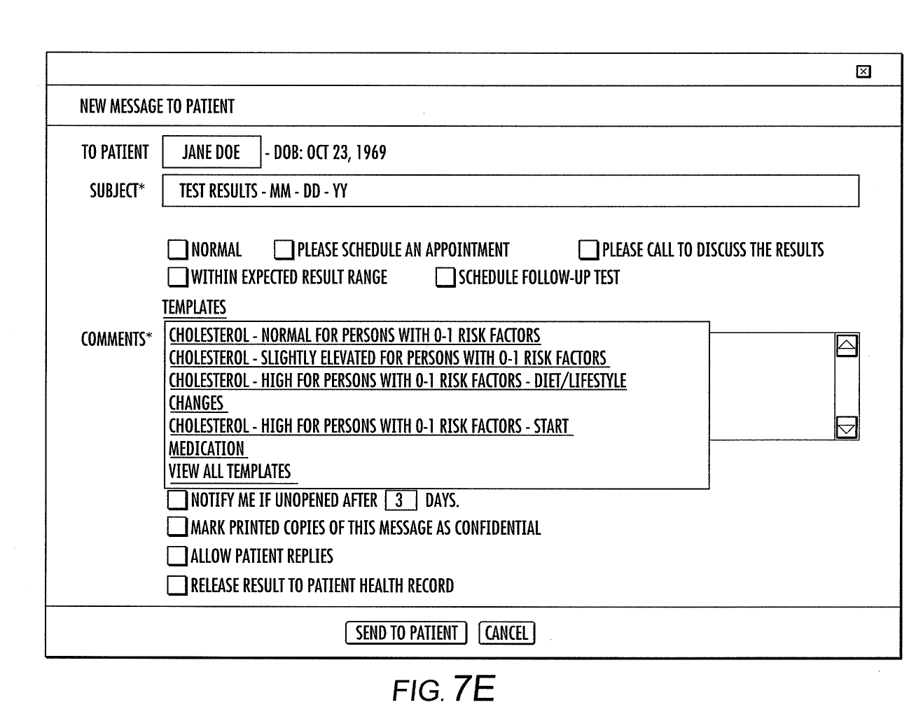

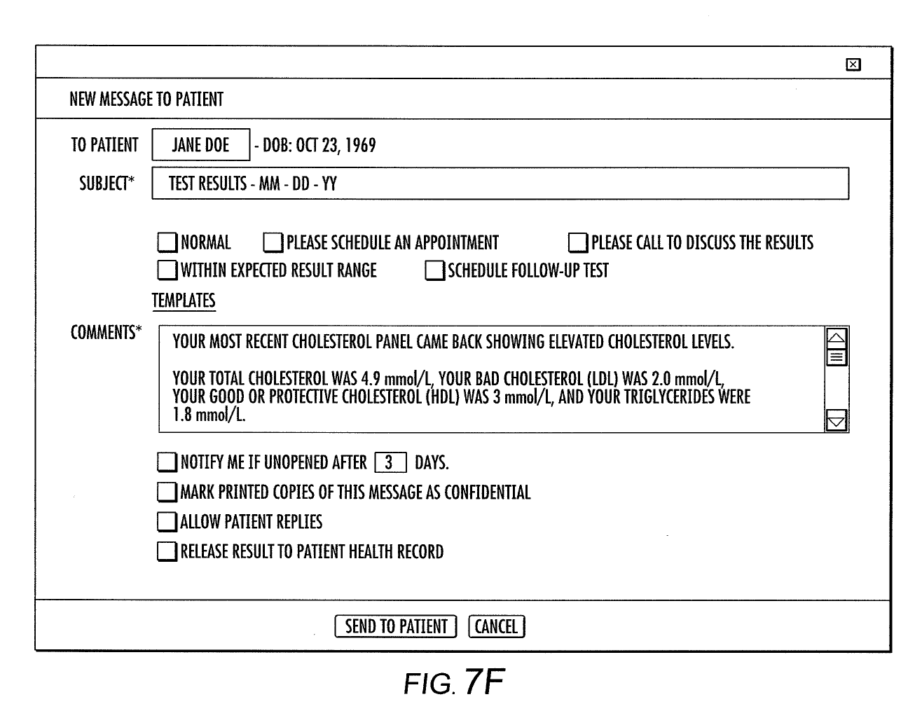

It should also be pointed out that when the server 54 receives the translated message(s) from the clients 50A, 50B and 50C, the respective client(s) is capable of translating the data in the message to a format or template that is specific to a respective EMR (e.g., an EpicCare clinic) in which the medical results associated with the received translated message is to be sent. For example, a translated message generated by a client may include LOINCs such as for example LOINC 2093-3, which relates to cholesterol, an example of which is shown in FIG. 6. (See also FIG. 7C) In this regard, the processor 84 of the server 54 may utilize the LOINCs to translate the data associated with the medical results in the translated message to a specific format or template that is utilized by the EMR (e.g., clinic) which maintains electronic apparatus 71, for example. An example of a template generated by server 54 which is specific to an EMR is shown in FIG. 7A, which may include the laboratory results associated with cholesterol tests for a patient(s). In an exemplary embodiment, the processor 84 of the server 54 may execute one or more software translation tools such as xlate or TCL script(s) that may be stored in a memory such as memory 86 to translate the data in the message sent from the client to a particular template utilized by a specific EMR.

During translation of the data to a specific EMR format or template, if the processor 84 of the server detects an error such as for example an inbound message format change/error, an error corresponding to the message will be written to an error log. The error log may be stored in a memory of the server. In situations in which the server may encounter an error translating the data in the translated message to a template that is specific to an EMR, the message is forwarded by the server to the respective electronic apparatus, (e.g., electronic apparatus 71) which may utilize its processor 84 to translate or convert the data in the message to a template specific to its EMR. The processor 84 of the electronic apparatus may execute one or more software translation tools such as xlate or TCL script(s), for example, to translate or convert the data in the message to a format specific template of its EMR.

In situations in which the server 54 is successfully able to translate or convert the data in the translated message to a template specific to an EMR, the processor of the server 54 may evaluate data in the translated message(s) and determine which electronic apparatus to send a message containing the template. In an exemplary embodiment, the processor of the server 54 may evaluate data in the message(s) which specifies an Internet Protocol (IP) address of the electronic apparatus(es). By using the IP addresses of the electronic apparatuses the server 54 is able to determine which electronic apparatus(es) should be sent the message containing the template.

When the messages containing the template are received by a respective electronic apparatus(es) (e.g., electronic apparatus 71) the data in the message associated with the template may be shown on a results viewer of a display such as display 80 as shown in the results viewer (also referred to herein as results manager) of FIG. 7A. Additionally, when the messages are successfully received by the electronic apparatuses of the EMRs, the respective electronic apparatus may send an acknowledgement (ACK) message to the server 54 which contains data indicating that the message was successfully received. In an alternative exemplary embodiment, the server 54 may send the ACK message that it received from an electronic apparatus to the electronic device that originally sent the message via a client. In this regard, the institution in which the electronic device is affiliated with is able to know that the message was successfully received by its intended source.

On the other hand, if the electronic apparatus did not successfully receive the message(s) sent by server 54, or did not receive the message in an error free manner the respective electronic apparatus may send the server a Negative Acknowledgement (NACK) message indicating that the message was not received successfully. The server 54 may send this NACK to the respective electronic device that generated the message to notify the personnel affiliated with the institution (e.g., hospital) maintaining the electronic device that the message was not successfully received by its intended recipient at an electronic apparatus. The ACK and NACK messages may utilize the HL7 standard. In an alternative exemplary embodiment when the server 54 receives an NACK message from an electronic apparatus, the processor of the server 54 may retrieve the message from the memory and resend the message to the respective electronic apparatus(es).

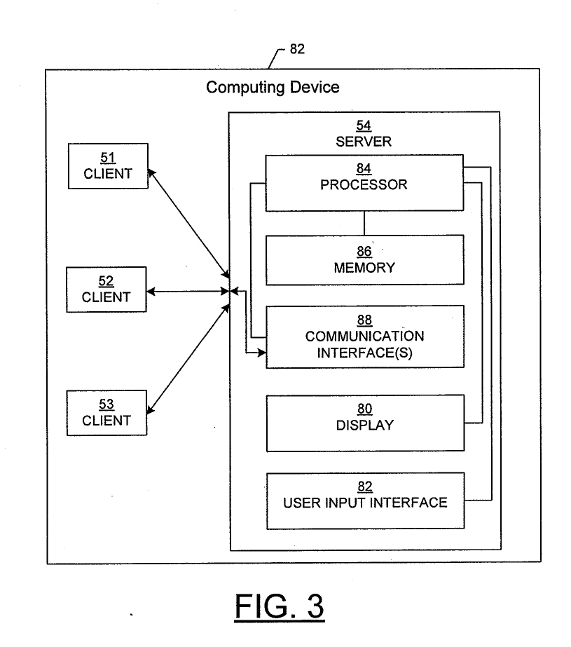

It should be pointed out that while the clients 40A, 40B and 40C and server 54 are shown as separated components in the system 12, in an alternative exemplary embodiment clients 40A, 40B and 40C as well as server 54 may be embodied in a single component such as a computing device 82 (also referred to herein as a Pathways Interface Manager (PWIM)), as shown in FIG. 3 or may be an application specific integrated circuit (ASIC). Additionally, while a client-server architecture is described herein by way of example, other computer architectures may be employed with more generic computing devices performing the various functions described herein in conjunction with the clients and the server.

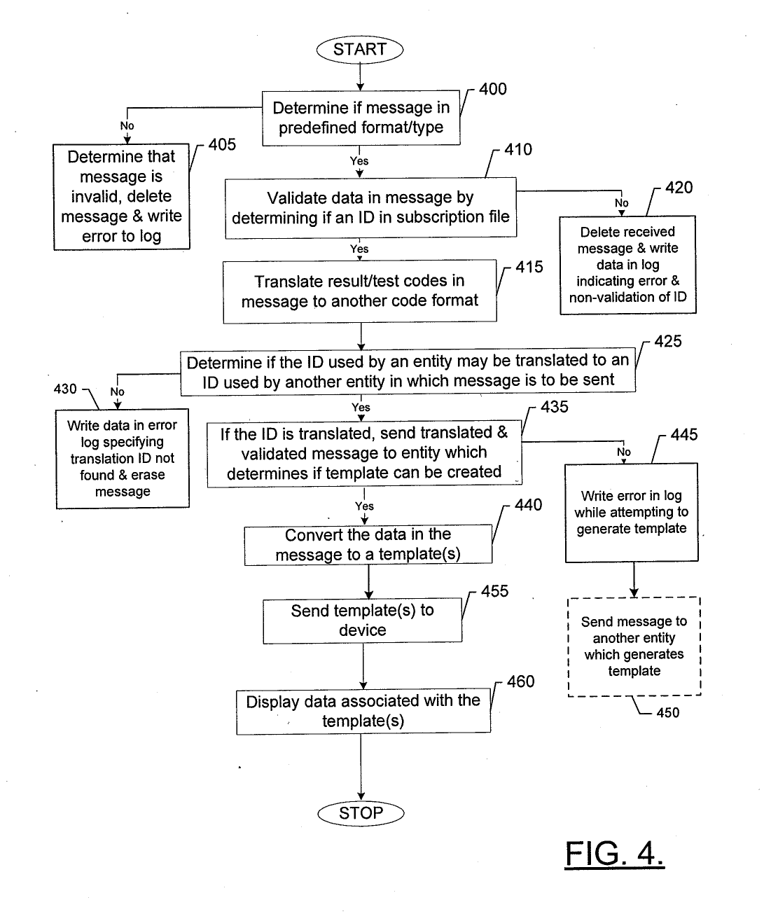

FIG. 4 illustrates a flowchart of a system for facilitating distribution of medical data. At operation 400, an electronic device (electronic device 40A) maintained by an institution (e.g., hospital) may send a message such as an ORU or MDM message for example, conforming to an HL7 standard, to a client (e.g., client 50A) which may validate that the received message is a ORU or MDM message. At operation 405, if the client determines that the received message is not a ORU or MDM message, the client determines that the type of message is invalid and the message is erased or deleted from memory and the client generates a log (e.g., error log) specifying that the message was deleted or erased and that an error occurred. At operation 410, if the client determines that the received message is an ORU or MDM message, the client validates the data in the message by determining if an identification (ID) in a subscription file provided by the electronic device matches the entity to which the medical results are to be sent, such as for example an EMR operating electronic apparatus 71. In an exemplary embodiment, the ID may relate to an ID of one or more physicians such as for example a primary and/or secondary physician (e.g., ordering physician and/or referring physician). Additionally, the ID may relate to a code(s) which identifies a provider such as one or more EMRs. At operation 415, the client determines if the ID is in the subscription file and if so the client translates the result or test codes in the message received from the electronic device to another code format such as one or more LOINCs. At operation 420, if the client determines that the ID is not in the subscription file, the client erases or deletes the received message and includes data in the log indicating that an error occurred and specifying that the ID was not validated.

At operation 425, the client attempts to translate the ID utilized by an entity (e.g., hospital or laboratory) of the electronic device to identify a corresponding EMR or personnel (e.g., doctor(s)) of the EMR to the corresponding ID employed by the EMR maintaining an electronic apparatus (e.g., electronic apparatus 71) and in which the message is to be sent. In an exemplary embodiment, the client may attempt to translate a physician ID employed by the entity maintaining the electronic apparatus (e.g., electronic apparatus 71) to a physician ID utilized by an entity (e.g., EMR) maintaining the electronic apparatus to identify the respective physician. This translation may occur by comparing ID(s) in the subscription file with a corresponding ID(s) in a translation table stored in a memory of the client. At operation 430, if the client is unable to identify a translation for the ID in the translation table, the processor 84 of the client may include data in an error log specifying that a translation was not found for the corresponding ID(s) and the corresponding message associated with ID sent by an electronic device (e.g., electronic device 40A) may be erased or deleted by the client.

At operation 435, if the ID was successfully translated by the client, the client sends the translated and validated message(s) to a server such as server 54 for example and processor of server 54 may determine if the data in the received message can be translated or converted to a template that is specific to an EMR in which the message is to be sent in the manner discussed above. At operation 440, if the determination reveals that the server can translate the data in the received message, the server 54 translates or converts the data into a specific template utilized by an EMR. At operation 445, if the server 54 is unable to translate the data in the received message to a template that is utilized by a particular EMR (e.g., the EMR in which the message is intended to be sent) the server may indicate in a log (error log) that an error occurred while attempting to generate a template and the received message may be erased or deleted by the processor of the server 54. Optionally, at operation 450, even though the server 54 was not able to generate a template that is specific to the EMR, the server 54 may send the received message to the corresponding electronic apparatus (e.g., electronic apparatus 71) maintained by the respective EMR and the processor of the electronic apparatus may translate the data in the received message to a specific template that it utilizes. At operation 455, if the server 54 is successfully able to generate a template that is specific to the respective EMR, server 54 may send data associated with the template in a message to an electronic apparatus(es) maintained and operated by one or more corresponding EMRs. The processor of the server 54 may determine the respective electronic apparatus in which to send the message by evaluating address (e.g., an IP address of the electronic apparatus(es)) information in the message sent from the client. Optionally, at operation 460, the electronic apparatus(es) may display the results on a results viewer via display 80.

In an alternative exemplary embodiment, one or more of the electronic apparatuses (e.g., electronic apparatus 73) may not be affiliated or operated by an EMR. For example, the respective electronic apparatus(es) that is not operated by an EMR may be operated by a health care facilitator such as for example the RelayHealth system which among other things provides communication services that connect doctors, their patients, health systems, pharmacies, etc. in a secure manner. In this regard, the health care facilitator maintaining the electronic apparatus 73 may operate a secure portal which may be a web-based portal for example and which links doctors, patients, and various health institutions (e.g., hospitals, Laboratory Information Systems, Radiology Information Systems or Transcription Systems, etc.) operating electronic devices 40A, 40B and 40C. A health care provider such as for example a doctor using an electronic apparatus such as electronic apparatus 71 (e.g., at a physician's facility) may access the secure portal via network 30 and may send a query (e.g., e-mail, facsimile, etc.) to one of the electronic devices 40A, 40B and 40C for medical data in a manner analogous to that discussed above. Additionally, the respective electronic device (e.g., electronic device 40A) may send the corresponding medical data in a message such as an HL7 message in the form of an ORU or MDM message in the manner analogous to that shown in FIG. 5. With reference to FIG. 5, as discussed above, the data in the message may contain various codes representative of medical data such as laboratory results, for example. The electronic device 40A may send the HL7 message to a client (e.g., client 50A) which may translate the test or result codes in the message to the healthcare industry standard logical observation identifiers, names, and codes (LOINCs) in the manner discussed above. As described above, an exemplary embodiment of a message that is translated by the processor of the client is shown in FIG. 6. The client may send the server 54 the translated message and the server 54 may then send the translated message to an electronic apparatus 73 maintained by the health care facilitator, in this example the RelayHealth system. In an exemplary embodiment, the server 54 may send the translated message to the electronic apparatus 73 by using the LAN, WAN, MAN, Internet or any other suitable network connection via network 30.

Once the message is retrieved by the electronic apparatus 73, the electronic apparatus 73 may format the data of the translated message in one or more templates utilized by the health care facilitator of the electronic apparatus 73 by utilizing the LOINCs. As shown in FIG. 7C, the LOINC 2093-3 relates to cholesterol and this LOINC, which may be in the translated message, can be used to generate one or more result templates associated with laboratory results of cholesterol levels, as shown in FIG. 7B. Thus, as seen in FIG. 7B, a cholesterol panel may correspond to several templates associated with the LOINCs, in this e.g., 2093-3 relating to cholesterol. In this regard, one or more template(s) associated with the data in the translated message received by the electronic apparatus 73 may be sent by the electronic apparatus 73 of the health care facilitator to an electronic apparatus (e.g. electronic apparatus 71) that may be maintained by the provider (e.g., doctor) and these templates may be shown in a results viewer (i.e., results manager) on display 80 of an electronic apparatus 71. As shown in FIG. 7B one or more templates relating to medical results (e.g., laboratory results) associated with cholesterol and corresponding to LOINC 2093-3 may be provided to the display 80 and shown in the Results Viewer of the electronic apparatus 71.

One or more of these templates may be selected by a person operating the electronic apparatus 71 or the electronic apparatus 71 may automatically make the selection of a template(s) based on a rule stored in its memory. As shown in FIG. 7C, a provider (e.g., doctor at a physician's facility) may utilize the user input interface 82 of the electronic apparatus 71 to select the template titled “Cholesterol—Name for persons with 0-1 Risk Factors” from among the 10 templates shown in FIG. 7B. As illustrated in FIG. 7D, the processor of electronic apparatus 71 may map the data associated with the medical results (relating to the LOINCs) to the selected template and in this regard, the processor may populate the results of the data in the selected template, in this example upon selecting the template titled “Cholesterol—Slightly Elevated for persons with 0-1 Risk Factors.” (For further details regarding use of mapping data associated with medical results to templates see application Ser. No. 11/951,032, the contents of which are incorporated by reference herein.) Additionally, as can be seen in FIG. 7D, the template(s) may display check boxes that are next to fields for analyzing or evaluating results that may be selected by personnel of the provider. The personnel can utilize the user input interface of electronic apparatus 71 for example to click on these check boxes to indicate that they want to communicate the data associated with the selected fields to the patient. When a person acting on behalf of the provider (e.g., doctor or other suitable representative) chooses the appropriate template(s) this template(s) may be sent to another electronic apparatus 71 of a patient which may be shown in a results viewer on display 80 of the electronic apparatus 71 that may be operated by the patient. In an exemplary embodiment, these templates may be sent in a message to a corresponding patient (e.g., Andrea Sim) as shown in FIG. 7E. In this regard, the patient may be provided with a patient-friendly message that is easy to understand. The transmitted message can be of any kind, including but not limited to a text message, fax, or e-mail. Additionally, the message can be printed out and mailed on a provider's letterhead, for example. The message sent to the patient can be tracked and audited to ensure patient security and privacy.

In another alternative exemplary embodiment, the results of the data that was selected in the template(s) may be sent to the electronic apparatus 71 of the patient so that this data can be shown on display 80 of electronic apparatus 71, for example as shown in FIG. 7F. Particularly, FIG. 7F shows that medical data (e.g., test results corresponding to cholesterol levels) associated with the selected fields of FIG. 7D may be included in the message that is sent to the electronic apparatus 71 of the patient. For instance, the selections in the template shown in FIG. 7D relating to “Your most recent cholesterol panel came back showing elevated cholesterol levels” and a “total cholesterol” of 4.9 mmol/L, bad cholesterol (LDL) of 2.0 mmol/L, good cholesterol or protective cholesterol (HDL) of 3 mmol/L and triglycerides of 1.8 mmol/L may be displayed in the message to be sent to the patient shown in FIG. 7F. Additionally, the provider (i.e., doctor in this example) sending the message to the patient may exclude certain recommendations such as for example the recommendation regarding aerobic exercise and decreasing fat in a diet or any other statements. It should be pointed out that the results viewer may also indicate if a patient(s) is a user or subscriber of the health care facilitator's service (e.g., the RelayHealth system) and may indicate whether the patient is connected to the portal, as shown in FIG. 7D.

It should be understood that each block or step of the flowchart shown in FIG. 4 and combination of blocks in the flowchart, can be implemented by various means, such as hardware, firmware, and/or software including one or more computer program instructions. For example, one or more of the procedures described above may be embodied by computer program instructions. In this regard, the computer program instructions which embody the procedures described above may be stored by a memory device of the mobile terminal and executed by a built-in processor in the mobile terminal. As will be appreciated, any such computer program instructions may be loaded onto a computer or other programmable apparatus (i.e., hardware) to produce a machine, such that the instructions which execute on the computer or other programmable apparatus (e.g., hardware) means for implementing the functions implemented specified in the flowcharts block(s) or step(s). These computer program instructions may also be stored in a computer-readable memory that can direct a computer or other programmable apparatus to function in a particular manner, such that the instructions stored in the computer-readable memory produce an article of manufacture including instruction means which implement the functions specified in the flowcharts block(s) or step(s). The computer program instructions may also be loaded onto a computer or other programmable apparatus to cause a series of operational steps to be performed on the computer or other programmable apparatus to produce a computer-implemented process such that the instructions which execute on the computer or other programmable apparatus provide steps for implementing the functions that are carried out in the system.

The above described functions may be carried out in many ways. For example, any suitable means for carrying out each of the functions described above may be employed to carry out the invention. In one embodiment, all or a portion of the elements of the invention generally operate under control of a computer program product. The computer program product for performing the methods of embodiments of the invention includes a computer-readable storage medium, such as the non-volatile storage medium, and computer-readable program code portions, such as a series of computer instructions, embodied in the computer-readable storage medium.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A method, comprising:
receiving medical data which comprises one or more medical codes representative of results;
translating the one or more medical codes to corresponding different codes which are also representative of the results;
automatically generating one or more templates based on the different codes, the templates comprising data indicative of the results; and
sending the one or more templates to a recipient.

2. The method of claim 1, further comprising, displaying the one or more templates.

3. The method of claim 1, wherein the medical data comprises one or more messages,

4. The method of claim 1, wherein the different codes comprise standardized code names and identifiers which identify medical data.

5. The method of claim 4, wherein the different codes comprise Logical Observation Identifiers Names and Codes (LOINCs).

6. The method of claim 3, wherein prior to translating one or more medical codes further comprising determining if at least one of the messages comprises one or more predetermined formats.

7. The method of claim 6, wherein when the at least one message comprises at least one of the predetermined formats, the method further comprises validating data in the at least one message based on an identifier relating to subscription data.

8. The method of claim 6, wherein when the at least one message does not comprise at least one of the predetermined formats, the method further comprises deleting the at least one message.

9. The method of claim 1, wherein receiving medical data further comprises receiving medical data from one or more devices, wherein the medical data comprises one or more formats corresponding to the respective devices.

10. The method of claim 9, wherein at least one format among the one or more formats is different from other formats of the one of more formats.

11. The method of claim 1, wherein the results comprises at least one of clinical results, laboratory results and medical diagnosis results.

12. The method of claim 1, further comprising:
receiving the one or more templates at the one or more entities and sending the one or more templates to the recipient.

13. An apparatus comprising a processing element configured to:
receive medical data which comprises one or more medical codes representative of results;
translate the one or more medical codes to corresponding different codes which are also representative of the results;
generate one or more templates based on the different codes, the templates comprising data indicative of the results; and
send the one or more templates to a recipient.

14. The apparatus of claim 13, wherein the one or more entities display the one or more templates.

15. The apparatus of claim 13, wherein the medical data comprises one or more messages.

16. The apparatus of claim 13, wherein the different codes comprise standardized code names and identifiers which identify medical data.

17. The apparatus of claim 16, wherein the different codes comprise Logical Observation Identifiers Names and Codes (LOINCs).

18. The apparatus of claim 15, wherein the processor is further configured to determine if at least one of the messages comprises one or more predetermined formats.

19. The apparatus of claim 18, wherein when the at least one message comprises at least one of the predetermined formats, the processor is further configured to validate data in the at least one message based on an identifier relating to subscription data.

20. The apparatus of claim 18, wherein when the at least one message does not comprise at least one of the predetermined formats, the processor is further configured to delete the at least one message.

21. The apparatus of claim 13, wherein the processor is further configured to receive medical data from one or more devices, wherein the medical data comprises one or more formats corresponding to the respective devices.

22. The apparatus of claim 21, wherein at least one format among the one or more formats is different from other formats of the one of more formats.

23. The apparatus of claim 13, wherein the results comprises at least one of clinical results, laboratory results and medical diagnosis results.

24. A computer program product, the computer program product comprising at least one computer-readable storage medium having computer-readable program code portions stored therein, the computer-readable program code portions comprising:
a first executable portion for receiving medical data which comprises one or more medical codes representative of results;
a second executable portion for translating the one or more medical codes to corresponding different codes which are also representative of the results;
a third executable portion for generating one or more templates based on the different codes, the templates comprising data indicative of the results; and
a fourth executable portion for sending the one or more templates to a recipient.

25. The computer program product of claim 24, wherein receiving data further comprises receiving medical data from one or more devices, wherein the medical data comprises one or more formats corresponding to the respective devices.

26. A system comprising:
an apparatus comprising a processing element configured to:
receive medical data which comprises one or more medical codes representative of results;
translate the one or more medical codes to corresponding different codes which are also representative of the results; and
generate one or more templates based on the different codes, the templates comprise data indicative of the results; and
an entity comprising a processing element configured to receive the one or more templates and display the one or more templates.

27. The system of claim 26, wherein the processing element of the apparatus is further configured to modify generated data in the one or more templates based on information specific to a user of the entity.
